(19) United States
(12) Patent Application Publication
(10) Pub. No.: US 2009/0070961 A1
(43) Pub. Date: Mar. 19, 2009

(54) Simultaneous-rotating hinge

(76) Inventors: Chia-Ko Chung, Shulin City (TW); Yu-Feng Lin, Shulin City (TW)

Correspondence Address: Hershkovitz & Associates, LLC, 2845 Duke Street, Alexandria, VA, 22314, US

(21) Appl. No.: 11/898,840

(22) Filed: Sep. 17, 2007

(51) Int. Cl. E05D 7/00

(52) U.S. Cl. 16/354

(57) ABSTRACT

A simultaneous-rotating hinge has a body, a first leaf and a second leaf. The body has a gear assembly. The gear assembly is mounted in the body and comprises multiple gears that engage each other. The first leaf is mounted rotatably on the body and connects to one of the gears in the gear assembly. The second leaf is mounted rotatably on the body and connects to another gear in the gear assembly. Interaction of the gears causes the first leaf and the second leaf to pivot simultaneously toward or away from each other.

### BACKGROUND OF THE INVENTION

1. Field of the Invention

The present invention relates to a hinge, and more particularly to a simultaneous-rotating hinge that facilitates manufacture and makes use of the hinge convenient.

2. Description of Related Art

Generally, a portable electronic device has a cover, a base and at least one hinge. The hinge is mounted between the cover and the base and allows the cover to pivot relative to the base.

With technology improving, various types of hinges mounted in portable electronic devices have been developed and have gradually become more and more complex. However, a basic technique of operating the hinges still includes pivoting the cover toward the stationary base. The cover is rotated through a wide angle to cover the base. Thus, for some portable electronic devices, especially for portable electronic devices with covers and bases in a flat arrangement, pivoting the cover onto the base can be inconvenient and troublesome.

To overcome the shortcomings, the present invention provides a simultaneous-rotating hinge to obviate or mitigate the aforementioned problems.

### SUMMARY OF THE INVENTION

The main objective of the present invention is to provide a simultaneous-rotating hinge that has a simple structure that facilitates manufacturing and makes rotating a cover and a base to which the cover is attached pivot simultaneously to make closing the cover against the base more convenient.

The simultaneous-rotating hinge in accordance with the present invention comprises a body, a first leaf and a second leaf. The body has a gear assembly. The gear assembly is mounted in the body and comprises multiple gears that engage each other. The first leaf is mounted rotatably on the body and connects to one of the gears in the gear assembly. The second leaf is mounted rotatably on the body and connects to another gear in the gear assembly. Interaction of the gears causes the first leaf and the second leaf to pivot simultaneously toward or away from each other.

Accordingly, pushing the cover attached to one leaf will cause the base attached to the other leaf to pivot simultaneously toward the cover and reduce the angle that the cover has to travel. Thus, portable electronic devices with the simultaneous-rotating hinge in accordance with present invention are convenient and easy to use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a simultaneous-rotating hinge in accordance with the present invention;

FIG. 2 is an exploded perspective view of the simultaneous-rotating hinge in FIG. 1;

FIG. 3 is an operational end view of the simultaneous-rotating hinge in FIG. 1 with the hinge open and being closed;

FIG. 4 is an end view of the simultaneous-rotating hinge in FIG. 1 with the hinge closed; and

FIG. 5 is an operational perspective view of the simultaneous-rotating hinge in FIG. 1 mounted on a portable electronic device.

### DETAILED DESCRIPTION OF THE PREFERRED EMBODIMENT

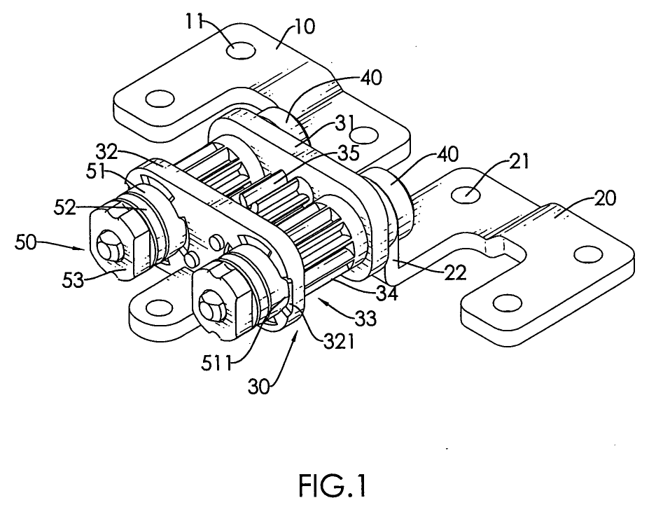

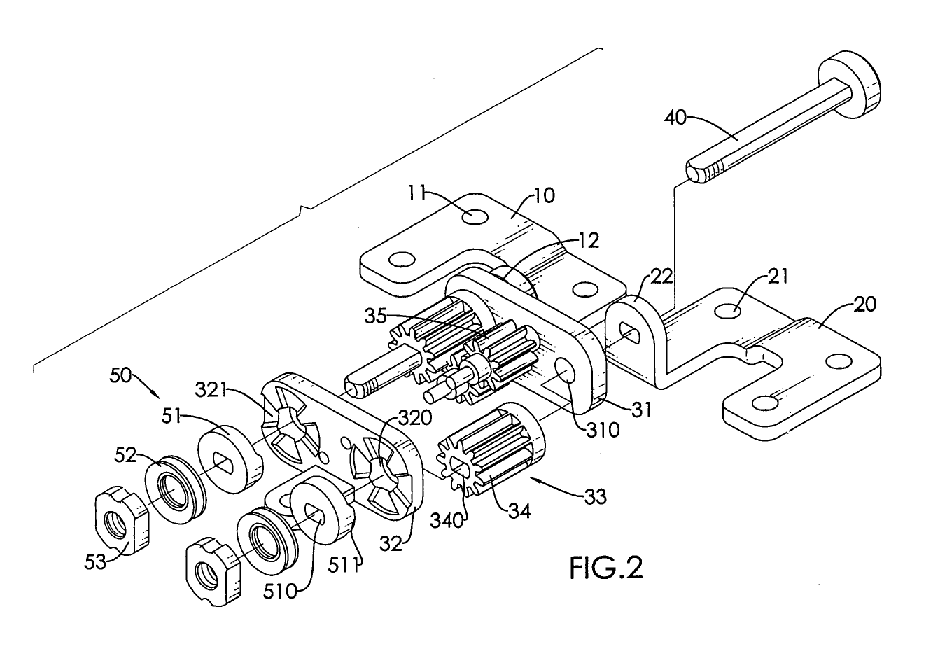

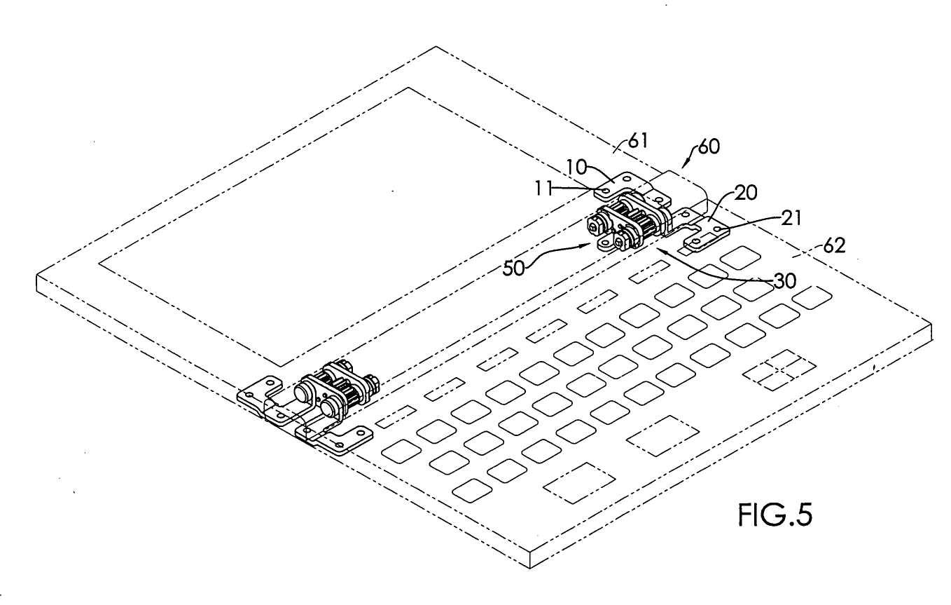

With further reference to FIGS. 1, 2 and 5, multiple simultaneous-rotating hinges in accordance with present invention are mounted on portable electronic devices (60) that include a cover (61) and a base (62), and the simultaneous- rotating hinge comprises a body (30), a first leaf (10) and a second leaf (20).

The body (30) has a frame, two mounting shafts (40), two positioning assemblies (50) and a gear assembly (33).

The frame comprises an outer mounting strip (31) and an inner mounting strip (32).

The outer mounting strip (31) has two ends, a middle, a top edge, a bottom edge, two shaft holes (310) and two pinholes. The shaft holes (310) are formed through the outer mounting strip (31) respectively near the two ends and are aligned with each other. The pinholes are formed near the middle of the outer mounting strip (31) and are offset respectively toward the top and bottom edges.

The inner mounting strip (32) is parallel to the outer mounting strip (31) and has two ends, a middle, a top edge, a bottom edge, an outer surface, two shaft holes (320), multiple detents (321) and two pinholes. The shaft holes (320) are formed through the inner mounting strip (32) respectively near the two ends, are aligned with each other and correspond respectively to the shaft holes (310) of the outer mounting strip (31). The detents (321) are formed in the outer surface around the shaft holes (320) and radially from the shaft holes (320). The pinholes are formed near the middle of the inner mounting strip (32) and are offset respectively toward the top and bottom edges.

The mounting shafts (40) are keyed and are rotatably mounted respectively through the shaft holes (310) in the outer mounting strip (31) and respectively through the shaft holes (320) in the inner mounting strip (32). Each mounting shafts (40) has an inner end. The inner ends may protrude respectively from shaft holes (320) in the inner mounting strip (32).

The positioning assemblies (50) are mounted respectively on the inner ends of the mounting shafts (40), and each positioning assembly (50) comprises a positioning element (51), a fastener (52) and a resilient washer (53).

The positioning element (51) is mounted slidably on the mounting shaft (40) and has an inner surface, a central keyhole (510) and two protrusions (511). The central keyhole (510) is formed through the positioning element (51) and corresponds to and is mounted slidably on the mounting shaft (40) so the positioning element (51) turns with the mounting shaft (40). The protrusions (511) are formed on and protrude from the inner surface of the positioning element (51) adjacent to the keyhole (510) opposite to each other and selectively engage the detents (321) of the inner mounting strip (32) to hold the mounting shaft (40) in place.

The fastener (52) is mounted securely on the inner end of the mounting shaft (40).

The resilient washer (53) is mounted around the mounting shaft (40) between the fastener (52) and the positioning element (5 1) and presses the positioning element (51) against the inner mounting strip (32) to make the protrusions (511) engage the detents (321).

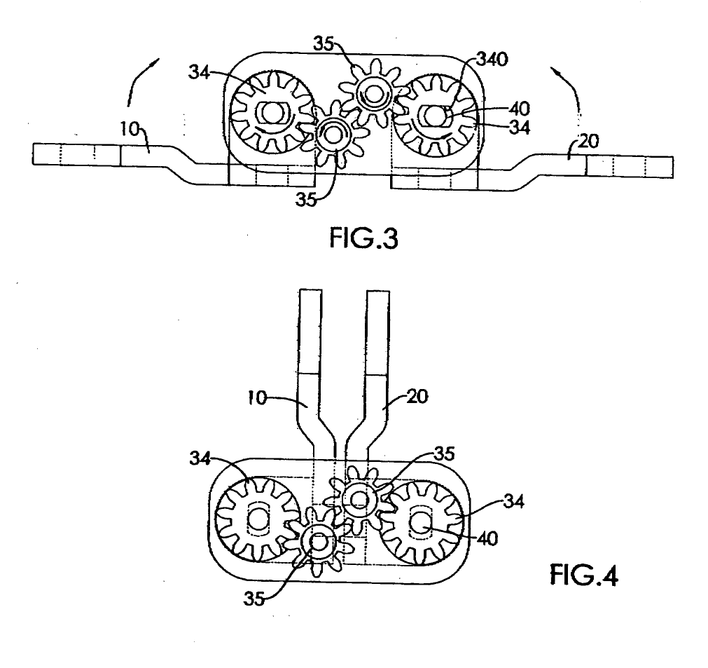

With further reference to FIGS. 3 and 4, the gear assembly (33) is mounted rotatably between the inner and outer mounting strips (31, 32) and includes multiple gears (34, 35). The gears (34, 35) engage each other and may comprise two main gears (34) and two pinion gears (35). The main gears (34) are mounted rotatably between the inner and outer mounting strips (31, 32) and securely mounted respectively on and rotate with the mounting shafts (40). Each main gear (34) has a central keyhole (340). The central keyhole (340) is formed coaxially through main gear (34), corresponds to and is mounted on the mounting shaft (40). The pinion gears (35) are rotatably mounted between the inner and outer mounting strips (31, 32) and between the main gears (34), respectively engage the main gears (34) and engage each other. Consequently, rotating one main gear (34) will cause the other main gear (34) to rotate in a complementary manner.

The first leaf (10) is flat, attaches to and rotates with one main gear (34) in the gear assembly (33), attaches to an electronic device and has two sides, multiple attachment holes (11) and a mounting tab (12). The attachment holes (11) are formed through the first leaf (10). The mounting tab (12) is formed on and protrudes perpendicularly from one side of the first leaf (10) and may have a keyed mounting hole or a mounting shaft (40). The keyed mounting hole is formed through the mounting tab (12) and corresponds to, is mounted on and rotates with the corresponding mounting shaft (40). The mounting shaft (40) is keyed, is formed on and protrudes perpendicularly from the mounting tab (12), is mounted through the corresponding shaft hole (310) in the outer mounting strip (31), the keyhole (340) in the corresponding main gear (34) and the central keyhole (510) in the positioning element (51) of the corresponding positioning assembly (50) and has an inner end. The inner end may protrude from the corresponding shaft hole (320) in the inner mounting strip (32).

The second leaf (20) is flat, attaches to an electronic device and has two sides, multiple attachment holes (21) and a mounting tab (22). The attachment holes (21) are formed through the second leaf (20) The mounting tab (22) is formed on and protrudes perpendicularly from one side of the second leaf (20) and may have a keyed mounting hole or a mounting shaft (40). The keyed mounting hole is formed through the mounting tab (22) and corresponds to, is mounted on and rotates with the corresponding mounting shaft (40). The mounting shaft (40) is keyed, is formed on and protrudes perpendicularly from the mounting tab (22), is mounted through the corresponding shaft hole (310) in the outer mounting strip (31), the keyhole (340) in the last corresponding main gear (34) and the central keyhole (5 10) in the positioning element (51) of the corresponding positioning assembly (50) and has an inner end. The inner end may protrude from the corresponding shaft hole (320) in the inner mounting strip (32). Consequently, rotating the second leaf (20) will rotate the first leaf (10) in a complementary direction, and rotating the first leaf (10) will rotate the second leaf (20) in a complementary direction.

Thus, the angle that the cover (61) has to rotate to cover the base (62) is reduced, and the portable electronic device (60) with the simultaneous-rotating hinge is more conveniently and easily used.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A simultaneous-rotating hinge comprising
a body having
a frame comprising
an outer mounting strip having two ends, a middle, a top edge, a bottom edge and two shaft holes being formed through the outer mounting strip respectively near the two ends and being aligned with each other; and
an inner mounting strip being parallel to the outer mounting strip and having two ends, a middle, a top edge, a bottom edge, an outer surface and two shaft holes being formed through the inner mounting strip respectively near the two ends, being aligned with each other and corresponding respectively to the shaft holes of the outer mounting strip; and
a gear assembly being mounted rotatably between the inner and outer mounting strips in the body and comprising multiple gears engaging each other;
a first leaf being flat, attaching to and rotating with one gear in the gear assembly and having
two sides; and
a mounting tab being formed on and protruding perpendicularly from one side of the first leaf; and
a second leaf being flat, attaching to and rotating with other one gear in the gear assembly and having
two sides; and
a mounting tab being formed on and protruding perpendicularly from one side of the first leaf.

2. The simultaneous-rotating hinge as claimed in claim 1, wherein
the body further has two mounting shafts being keyed and being rotatably mounted respectively through the shaft holes in the outer mounting strip and respectively through the shaft holes in the inner mounting strip, and each mounting shafts having an inner end;
the gears of the gear assembly comprise
two main gears being mounted rotatably between the outer mounting strip and the inner mounting strip, and each main gear having a central keyhole being formed coaxially through the main gear and aligning with corresponding shaft holes in the outer mounting strip and the inner mounting strip, and the keyholes corresponding to and being mounted respectively on the mounting shafts; and
two pinion gears being rotatably mounted between the outer mounting strip and the inner mounting strip, engaging the main gears and engaging each other;
the mounting tab of the first leaf has a keyed mounting hole being formed through the mounting tab and corresponding to, being mounted on and rotating with the corresponding mounting shaft; and
the mounting tab of the second leaf has a keyed mounting hole being formed through the mounting tab and corresponding to, being mounted on and rotating with the corresponding mounting shaft.

3. The simultaneous-rotating hinge as claimed in claim 2, wherein
the inner mounting strip of the frame of the body further has multiple detents being formed in the outer surface around the shaft holes and radially from the shaft holes;
the inner ends of the mounting shafts protrude respectively from shaft holes in the inner mounting strip; and
the body further has two positioning assemblies being mounted respectively on the inner ends of the mounting shafts, and each positioning assembly comprising
a positioning element having
an inner surface;
a central keyhole being formed through the positioning element and corresponding to and being mounted slidably on the mounting shaft; and
two protrusions being formed on and protruding from the inner surface of the positioning element adjacent to the keyhole opposite to each other and being selectively engaging the detents of the inner mounting strip;
a fastener being mounted securely on the inner end of the mounting shaft; and
a resilient washer being mounted around the mounting shaft between the fastener and the positioning element and pressing the positioning element against the inner mounting strip.

4. The simultaneous-rotating hinge as claimed in claim 2, wherein
the first leaf further has multiple attachment holes; and
the second leaf has multiple attachment holes.
